(19) United States
(12) Patent Application Publication
(10) Pub. No.: US 2008/0290279 A1
(43) Pub. Date: Nov. 27, 2008

(54) Method for Standardising a Spectrometer

(75) Inventor: Henrik Vilstrup Juhl, Roskilde (DK)

Correspondence Address: HARNESS, DICKEY & PIERCE, P.L.C., P.O. BOX 8910, RESTON, VA, 20195, US

(73) Assignee: FOSS ANALYTICAL A/S, Hillerod (DK)

(21) Appl. No.: 11/793,036

(22) PCT Filed: Dec. 16, 2005
(86) PCT No.: PCT/DK05/00798

§ 371 Date: Jun. 15, 2007

(30) Foreign Application Priority Data
Dec. 21, 2004 (DK) PA 2004 01965

(51) Int. Cl. G01J 3/28

(52) U.S. Cl. 250/339.08

(57) ABSTRACT

The invention provides a method for standardising an infrared spectrometer based on spectral patterns of constituents of atmospheric air naturally occurring in the spectrometer. The invention also provides a spectrometer applying the method. The method selects a spectral pattern in a recorded spectrum and determines a wavelength dependent position value for a feature, such as the centre of the pattern. This value is compared to a reference value that may be obtained from a spectrum recorded by a master instrument, and a standardisation formula can be determined. The absorption peaks from CO₂ (_{g}) around 2350 cm⁻¹ are preferred as the selected pattern. The method renders the use of reference samples unnecessary and allows for the standardisation to be performed simultaneously with the recording of a spectrum of a sample of interest.

### FIELD OF THE INVENTION

The present invention relates to a method of standardising an infrared spectrometer and to an infrared spectrometer and elements thereof operable according to the method.

### BACKGROUND OF THE INVENTION

In traditional (dispersive) spectrometers for generating optical spectra from samples, a light emitter and a light detector are comprised which define a light path into which the sample in question is positioned in order to have the sample interact with the light. Typically, such spectrometers additionally comprise means for holding the sample, such as a sample cuvette for holding liquid samples, the material of which additionally interacts with the light. Furthermore, mirrors, prisms, gratings, lenses and the like may also be introduced in the light path in order to deflect the light.

The optical spectra are typically absorption spectra, transmission spectra or reflection spectra. However, also emission spectra, such as fluorescence spectra or Raman spectra, are used.

The state of the different optical elements and light sources may vary over time and/or with the conditions of the surroundings. Such variations will influence the output of the light detector and thus the spectrum generated by the spectrometer. Typically, the drift of the spectrometer may be described as a wavelength drift as a cause of which the same wavelength may not be represented identically by two otherwise similar spectrometers, and an intensity drift in which different intensities are measured at the same wavelengths for the same sample in two otherwise similar instruments. Therefore, spectrometers generally need standardisation at regular intervals in order to produce precise spectra.

Numerous methods for standardising spectrometers are described in the prior art. In a typical standardisation procedure, the spectrometer is brought into standard with a master instrument. The master instrument has been used to record a large number of spectra of known samples, which have again been used to generate a database linking a given absorbance at one or more wavelengths to an amount of a substance. In order to apply this database, the wavelength scale of the spectrometer must be standardised to the wavelength scale of the master instrument. To do this, most prior art methods make use of a known reference sample to be used in a standardisation procedure. The spectrum of the known reference sample is recorded and compared with the spectrum of an identical sample recorded by the master instrument. A standardisation formula for the spectrometer is determined which is used to correct for wavelength discrepancies in a recorded spectrum.

Fourier transform infrared (FTIR) spectroscopy is a kind of spectroscopy in which infrared spectra are collected by using a certain measurement technique. In traditional infrared spectrometers, the wavelength of the IR light is varied and the amount of energy absorbed is recorded. In an FTIR spectrometer, light from an IR source is guided through an interferometer together with monochromatic light from a laser. When the IR light has interacted with a sample, the signal measured is an interferogram. Carrying out a mathematical Fourier Transform on this signal yields a spectrum identical to that of a traditional infrared spectroscopy. Practically all infrared spectrometers used today are of the FTIR type, due to their various advantages over the traditional instruments.

Such FTIR instruments make use of a laser emitting at a certain wavelength as a reference. Lasers are not resistant towards temperature changes and mechanical influences, both of which may cause drift in the emission wavelength.

Previously, a typical laser used in FTIR spectrometers has been a HeNe-laser applied for use under conditions in which the laser is very stable. In newer FTIR spectrometers, there is a desire to use solid state lasers that are generally smaller, less fragile and cheaper than HeNe-lasers. However, solid state lasers are even more temperature sensitive which put higher demands on the thermal stabilisation and require frequent standardisation.

Busch et. al., Applied Spectroscopy, 54, 1321 (2000) (XP001125094) discloses calibration of an FT-NIR spectrometer by the use of an ethyne sample cell and comparison with rovibrational band values provided by the National Institute of Standards and Technology.

It is a clear disadvantage, in means of working time and precision of the existing methods for standardisation or calibration, that they require the regular introduction of a reference sample for standardisation of the spectrometer. Reference samples may degrade, break or become lost, in which case a new sample has to be obtained before the spectrometer can be standardised.

U.S. Pat. No. 6,420,695 discloses a method for wavelength calibration for an electromagnetic radiation filtering device (wavelength filter), here a tunable Fabry-Perot interferometer. The method comprises tuning of the spectral transmission based on initially established relations between a central wavelength and a physical parameter, here a voltage over the Fabry-Perot interferometer. The use of absorbing lines of methane or CO₂ in the calibration is mentioned. U.S. Pat. No. 6,420,695 will be commented on later in the description.

### SUMMARY OF THE INVENTION

As can be seen from the above, there is a demand for spectrometers with less extensive standardisation procedures and which relax the requirements for e.g. precision in the production of parts and working temperature. Such spectrometer may also be applicable in e.g. field research or other exposed situations where repetitive, time-consuming standardisation is a nuisance.

It is therefore an object of the present invention to provide a method of standardising a spectrometer without the need for use of a reference sample for the standardisation.

It is another object of the present invention to provide a spectrometer suitable for use under less stable conditions, in particular under varying temperature conditions.

It is still another object of the present invention to standardise a spectrometer each time a sample is introduced thereby providing an improved precision of the generated optical spectra of the samples introduced into the spectrometer.

It is yet another object of the present invention to standardise a spectrometer using a recorded spectrum of a sample of interest, thereby avoiding the disadvantage of having to record separate spectra for standardisation and for samples of interest.

In a first aspect, the invention provides a method for adjusting the wavelength scale of an optical spectrum recorded by a spectrometer
providing an optical spectrum recorded by the spectrometer and comprising spectral patterns originating from constituents of atmospheric air in the spectrometer,
selecting a spectral pattern originating from constituents of atmospheric air in the spectrometer,
determining a wavelength dependent position value associated with the selected spectral pattern, and
adjusting a wavelength scale of the optical spectrum based on a difference between the determined value and a corresponding reference value of the selected spectral pattern.

Preferably, the step of determining a wavelength dependent position value includes determining a value of a centre of the selected spectral pattern. More preferably determining the centre value comprises removing spectral components from other substances within a predetermined wavelength range surrounding the selected spectral pattern. In a preferred embodiment, the removal of spectral components comprises the steps of:
selecting at least two spectral values inside a predetermined wavelength range comprising the selected spectral pattern, the values lying on both sides of, and outside of, said spectral pattern,
fitting a curve to the selected spectral values using a simple model function, and
subtracting the fitted curve from the optical spectrum, at least for the predetermined wavelength range of the optical spectrum.

Preferably, the spectrum is a spectrum recorded of a sample of interest, meaning a sample whose spectrum is the goal of the measurement, not a sample used for calibration purposes (typically denoted reference sample or calibration sample). In the remaining description, the term sample generally refers to the sample of interest unless otherwise indicated. Preferably, the sample is a liquid sample, but the method may also be applied to solid or gaseous samples. Further, the method is preferably used in FTIR spectroscopy, in which case the spectrometer is an FTIR spectrometer or equivalent, but may be used in any kind of spectroscopy.

When standardising the wavelength axis of a spectrometer, it will be required to obtain information relating to the recorded wavelength of a characterising pattern whose true wavelength is known. The characteristic pattern is typically one or more absorption or emission peaks originating from a well-known transition between quantum mechanical energy states of the relevant molecule. On the other hand, it may originate from a complex interaction and occupy a larger part of the spectrum. Thus, it is preferred that the characteristic pattern comprises one or more local maxima or minima, i.e. spectral peaks, of the optical spectrum.

Preferably, the spectral pattern comprises two peaks originating from the covalent bonds in gaseous CO₂. One is for the anti-symmetric stretching mode and one for the bending mode. These peaks are located in the interval 2000-2800 cm⁻¹, at approximately 2335 cm⁻¹ and 2355 cm⁻¹, and overlap at normal CO_{2 (g)} quantities. Hence, the centre frequency of the spectral pattern arising from these two peaks is defined as the centre of the combined pattern. Also, the predetermined wavelength range is preferably centred at 2345 cm⁻¹, whereas the width of the predetermined wavelength range depends on the selected process for determining the centre value.

The spectral peaks of the absorption of gaseous CO₂ are themselves independent of temperature variations, but their position on the wavelength axis will vary depending on e.g. the temperature. This is especially true for FTIR spectrometers, where the wavelength of the reference laser source may vary with the temperature.

A correct targeting of said spectral peaks of the gaseous CO₂ absorption, however, is dependent on the absence of other constituents absorbing in the same wavelength range. This will almost always be the situation when handling aqueous solution samples of food stuffs, such as milk, wine or fruit juices. Aside from water, H₂O, which has a very even absorption in the wavelength range, there will be no other constituents affecting the localisation of the CO₂ absorption peaks.

Typically, the only possible disturbance of the CO₂ absorption in the wavelength arises from dissolved CO_{2 (aq)} in the sample itself. However, such dissolved CO₂ only has one absorption peak situated between the absorption peaks from the gaseous CO₂. This possible disturbance is consequently easily overcome because of the circumstances identified below.

First, only a very small maximum concentration of dissolved CO₂ is possible in the samples, since larger concentrations will result in the CO_{2 (aq)} being released in gaseous form at standard atmospheric pressure. Therefore, though the absorption of dissolved CO₂ overlaps with the peaks from CO_{2 (g)}, the absorption of dissolved CO₂ will be significantly less than that of the CO_{2 (g)} and hence easily distinguished and excluded from the standardisation calculations.

Secondly, the absorption spectrum of dissolved CO₂ lies almost symmetrically between the peaks from CO_{2 (g)} and will be so narrow at all concentrations below the above mentioned maximum concentration, that it will not affect the outer “flanks” of the CO_{2 (g)} peaks. If it does distort the flanks, it will be an almost symmetric distortion which does not shift the centre between the flanks. Hence, although it may change the shape of the peaks from gaseous CO₂, it does not change the position of its centre. In this application, “flanks” may be construed as positions on both sides of the spectral peaks of the gaseous CO₂ where the absorption value is equal to a predefined percentage of the minimum absorption value. However, other definitions may apply, e.g. the “flanks” could be defined as positions in the absorption spectrum with equal, numerical slope values on the curve.

Since the spectrometer uses the naturally occurring gaseous CO₂ of the ambient atmosphere to carry out the standardisation procedure, there is no need for a reference sample to be placed in the spectrometer during the standardisation. In other words, the reference sample is always present in the spectrometer. The concentration or partial pressure of CO_{2 (g)} in air, and therefore in the spectrometer, is typically ˜0.03. This number may easily change, if e.g. the operator breathes close into the spectrometer. The amount of CO_{2 (g)} affects the height/depth of the peaks and thereby also their flanks. As the two spectral peaks are almost of same height/depth, the centre wavelength is not dependent on the amount of CO_{2 (g)}.

The method of standardising a spectrometer according to the present invention is carried out within a very short period of time compared to the traditional solutions where a standard sample has to be introduced. Typically, the selected spectral pattern is obtained together with the spectrum of a sample, and the following standardisation calculations can be performed within one second with the aid of a computing part of the instrument. However, it is preferred that this process is repeated for a predetermined number of times, in order to increase the precision of both the standardisation and the sample spectrum by calculation of mean values. Thereby, the present invention saves a lot of time since only one series of spectra needs to be recorded, instead of one for the sample and one for the reference sample.

As described above, the standardisation of the spectrometer may be performed without a reference sample being placed in the spectrometer. Instead, the standardisation according to the invention is preferably carried out every time the spectrum of a sample of interest is recorded, i.e. both the spectrum of the selected constituents of atmospheric air and the spectrum of the sample will be recorded at the same time. Whereas the light/matter interaction causing the constituent spectrum for the standardisation purpose takes place in the beam path, the spectrum of the sample is generated in the sample cuvette or container. This means that the relative strength of peaks in the final spectrum may depend on the physical set-up of the spectrometer, e.g. a compact design using solid optical fibres for guiding the light may show much lower atmospheric air related peaks, e.g. CO₂ (g) related.

It thus follows that the adjusting of the wavelength scale according to the present invention applies selected spectral pattern preferably originating in the spectrum of the sample of interest. Hence, the recording of the selected spectral pattern applied in the adjusting of the wavelength scale is preferably recorded simultaneously as the spectrum of the sample of interest.

In a second aspect, the invention provides an infrared spectrometer to be standardised using the method of the first aspect. Accordingly, the second aspect provides an infrared spectrometer comprising a measuring part and a computing part, the measuring part comprising a light source for emitting infrared light, means for positioning a sample to be illuminated by the infrared light, a light detector positioned to receive infrared light having interacted with the sample, and the computing part comprising
means for generating an optical spectrum from data received from the light detector,
data defining a predetermined wavelength range of the optical spectrum in which a spectral pattern originating from a constituent of atmospheric air in the spectrometer lies,
means for determining a wavelength dependent position value associated with the selected spectral pattern, and
means for comparing the determined value with a corresponding reference value and calculating a standardisation formula for the optical spectrum.

Preferably, determining the position value comprises determining a centre value of the selected spectral pattern. In order to simplify the procedure for this, it is preferable that the computing part further comprises means for at least substantially removing spectral components from the light source and other substances, at least within the predetermined wavelength range.

According to the second aspect, the spectrometer is equipped with a suitable light detector positioned to receive infrared light having interacted with the sample. The light detector may be e.g. a photo cell, a photo transistor, a photo resistor or a photodiode, in particular a PIN photodiode, since such a diode is very sensitive in the infrared and near-infrared wavelength areas.

The computing part typically comprises a hardware component and a software component for performing the standardisation calculations. The hardware component may essentially be the equivalent of a personal computer with a possible extended storage medium for storing a large number of sample results when e.g. working in the field without time for immediate analysis of the results.

The software component may preferably comprise previously stored spectra from a master instrument and/or data defining the position of the selected spectral pattern e.g. in a spectrum recorded by the master instrument. These data are supplied for use as reference values when generating a standardisation formula for correcting the spectra from each new sample in order to standardise the wavelength axis of the spectrometer.

The spectrometer according to the second aspect may be a master instrument used for determining reference values and other data.

The software component may further comprise one or more computer programmes involving algorithms for carrying out the standardisation calculations in a manner substantially equal to the method described above in connection with the first aspect of the invention. Hence, the means comprised by the computing part may be parts of these programs.

In order to determine e.g. a centre value for the CO_{2 (g)} peaks, spectral components from other substances within the predetermined wavelength range should be removed as they may distort the spectrum. Similarly, the emission spectrum of the infrared light source of the spectrometer should be accounted for. This may be done in a number of ways.

In a preferred embodiment employing the CO_{2 (g)} peaks, the means for at least substantially removing spectral components comprises an algorithm for performing the following steps:
selecting at least two spectral values inside the predetermined wavelength range, the values lying on both sides of, and outside of, said spectral pattern,
fitting a curve to the selected spectral values using a simple model function, and
subtracting the fitted curve from the optical spectrum, at least for the predetermined wavelength range of the optical spectrum.

A simple model function is the mathematical function used to approximate a curve through the selected values in the curve fitting. As no other typically present substances have fast varying spectra in the predetermined wavelength range, the object is to fit the “back-ground curve” to the CO₂ peaks—hence, the selected values should lie well outside the characterising pattern of the CO₂ peaks.

Also, the curve should behave smoothly between the selected points so as produce a realistic extrapolation over the characterising pattern of the CO₂ peaks. This can be achieved by choosing a simple model function which can not change behaviour (such as change sign of first derivative) between the selected values. Such curve may be a second order polynomial.

The fitted curve will subsequently be subtracted from the optical spectrum, at least for the predetermined wavelength range of the optical spectrum, whereby the spectral components from other substances than CO₂ will not be able to interfere with the optical spectrum of the CO₂. This approach assumes that no other present substance has a fast varying spectrum that overlaps with the CO_{2 (g)} peaks. Any slowly varying spectrum is simply filtered out by the interpolation of the fitted curve.

In another embodiment that may also employ the CO_{2 (g)} peaks, the means for determining a wavelength value comprises an algorithm for performing the following steps:
determining a minimum spectral value within the predetermined wavelength range,
identifying spectral edge values being a predetermined percentage of the minimum value,
determining a value for the centre between the spectral edge values, this centre value being the value for the centre of the spectral pattern.

In a preferred embodiment, the spectrometer is an FTIR spectrometer applying a thermal infrared light source and a laser. Preferably, the laser is a solid state laser such as a diode laser or a vertical cavity surface-emitting laser (VCSEL). The emission wavelength of such lasers is much dependent on the temperature of the surroundings and frequent standardisation is of high importance.

The preferred specifications disclosed in connection with the method according to the first aspect may as well apply correspondingly to the spectrometer of the second aspect.

The invention may be implemented as a software package to be distributed and installed in a computing part of an existing spectrometer. For this purpose, a third aspect of the invention provides a data carrier holding data representing
software means for generating an optical spectrum from optical frequency data and corresponding spectral data,
data defining a predetermined wavelength range of the optical spectrum in which a spectral pattern originating from a constituent of atmospheric air lies and a reference value for a wavelength dependent position value of a predetermined feature of the spectral pattern,
software means for determining a wavelength dependent position value for the predetermined feature of the spectral pattern in the optical spectrum, and
software means for comparing the determined value with the reference value and calculating a standardisation formula for the optical spectrum.

The data carrier may e.g. be a hard disk, a CD-ROM, a USB connectable storage device, or any other appropriate data carrier.

The preferred specifications disclosed in connection with the method according to the first aspect may as well apply correspondingly to the data carrier of the third aspect. Also, the preferred specifications disclosed in connection with the computing part of the spectrometer according to the second aspect may apply to the data carrier of the third aspect.

It is a disadvantage of the calibration method provided in U.S. Pat. No. 6,420,695 that the calibration of the wavelength filter must be carried out in an independent procedure, and can therefore not be carried out at the same time as a spectrum of a sample of interest is recorded. In contrast, the standardisation of a spectrometer according to the present invention is carried out using a recorded spectrum, preferably a spectrum of a sample of interest.

Further, the calibration method provided in U.S. Pat. No. 6,420,695 provides a wavelength calibration, λ(V), of a singular component (wavelength filter) of an instrument. It does therefore not provide a standardisation of the instrument as such. Consequently, calibration samples are used to calibrate other parts of the instrument; Column 6, lines 21-27 indicates that a known standard gas (i.e. a calibration sample) must be use to calibrate the ‘meter’; similarly, Column 9, lines 23-31 and 63-65 indicates that a known gas mixture is used in the calibration. U.S. Pat. No. 6,420,695 thereby fails to provide the advantage of the present invention that no reference or calibration sample is needed to standardize the spectrometer.

In preferred embodiments, the present invention relates to FTIR spectrometry where no wavelength filter is used, in which case the disclosures of U.S. Pat. No. 6,420,695 does not apply.

It is the essence of the present invention to let atmospheric air in the spectrometer perform the function of a reference sample. This method provides a precise, fast, reliable and easy standardisation of a spectrometer. The pure simplicity of the invention allows for a more frequent standardisation with less chance of mechanical or human errors, and consequently provides a more correct measurement of the optical spectra of the sample. The method also renders the use of reference samples unnecessary, and allows for the standardisation to be performed simultaneously with the recording of a spectrum of a sample of interest.

In the present description, it is emphasised that terms as “value” and “feature” includes the plural.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 is an illustration of an FTIR spectrometer according to a preferred embodiment of the invention.

FIGS. 2A and B are graphs showing the interferograms of the light source and the laser of the FTIR spectrometer of FIG. 1.

FIG. 3 are graphs showing spectra of constituents of atmospheric air.

FIG. 4 is a graph showing FTIR spectra of different samples.

FIG. 5 is a graph showing enlarged sections of the spectra of FIG. 4.

FIGS. 6A-B and 7A-B are graphs illustrating the determination of a centre value according to a preferred embodiment of the invention.

### DETAILED DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognise additional modifications, applications, and embodiments within the scope thereof and additional fields in which the present invention would be of significant utility.

Naturally, optical spectra may be generated from virtually any type of sample, such as gaseous samples, solid samples, such as cheese, grain or meat, or liquid samples, such as milk or milk products. In general, optical spectra are often used in order to characterise, that is, determine the concentration of constituents therein, a wide variety of products, such as dairy products, as is the case in a preferred embodiment of the invention.

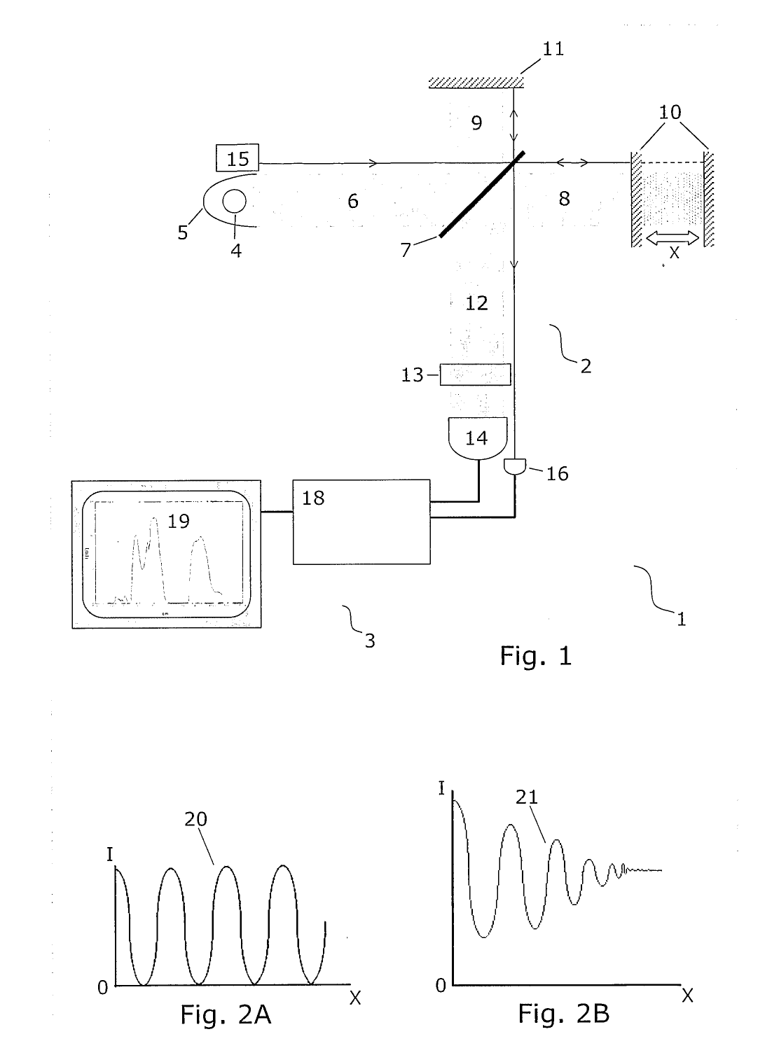

FIG. 1 shows the layout of a preferred embodiment of an infrared spectrometer 1 according to the invention. The spectrometer 1 is an FTIR spectrometer and has a measuring part 2 and a computing part 3.

The measuring part 2 comprises a thermal infrared light source 4 and a reflector 5 for emitting and infrared light beam 6. The IR beam 6 is split by a beam splitter 7 giving rise to a primary and a secondary beam 8 and 9. The primary beam 8 is reflected by movable mirror 10 whereas secondary beam 9 is reflected by fixed mirror 11. Reflected beams overlap at the beam splitter to give interference beam 12. A cuvette or container 13 for holding a sample is positioned in the beam path of the interference beam 12 and an infrared light detector 14 is positioned to receive infrared light having interacted with the sample.

The interferometer also includes a reference laser source 15 which follows the same path through the interferometer, after which it is intercepted and directed at a laser detector 16. Upon movement of mirror 10, coherent, monochromatic light, such as the laser beam, passing through the interferometer gives rise to an interference signal at the detector 16. This signal (interferogram 20 in FIG. 2A) is oscillating as a function of position X of the mirror 10 due to constructive and destructive interference. The interferogram is a series of data points (position vs. intensity) collected during the smooth movement of the mirror 10, and by counting the maxima (fringes) in the separately monitored laser interferogram 20, the position of the moving mirror 10 can be determined accurately.

When a multi-wavelength spectrum, i.e. from the IR source 4, enters the interferometer, the combination of many different frequencies and intensities produce an interferogram 21 in FIG. 2B which is much different from the interferogram 20 from the laser. At small path differences, the same wavelengths from the primary and secondary beam will interfere giving rise to an oscillation in the intensity of the interference beam 12. As the mirror 10 is moved far away from zero path difference (large X), the lack of coherence of light source 4 makes the oscillation die out.

Using Fourier Transformation, the computing part 3 is able to de-convolute all the individual cosine waves that contribute to the interferogram 21, and so produce a plot of intensity against wavelength, or more usually the frequency in cm⁻¹; i.e. the infrared single beam spectrum 19. All data points from interferogram 21 and the precise movement of the mirror 10 (obtained from interferogram 20) are necessary to obtain the spectrum. Therefore, the computing part 3, typically a computer 18, is connected to detectors 14 and 16 and comprises software means for generating the optical spectrum 19 from data received from the detectors.

In determining the position of mirror 10, the exact wavelength of laser 15 must be known by the computing part 3. Typically, a wavelength from the product specification of the laser is stored in the computer 18. However, this wavelength is only accurate within a given interval, and the laser wavelength also varies strongly with temperature. Therefore, the true laser frequency may be much different from the assumed laser frequency applied by the computation part 3 when spectrum 19 is calculated, which ultimately leads to wrong reading of amounts of substances in the sample. Therefore, spectrometers should be standardised regularly.

As previously described, typical standardisation procedures consist of recording a spectrum of a known reference sample and compare it with the spectrum of an identical sample recorded by a master instrument. The spectra are overlapped, and a standardisation formula for the spectrometer is determined. The present invention provides an easier and more reliable method.

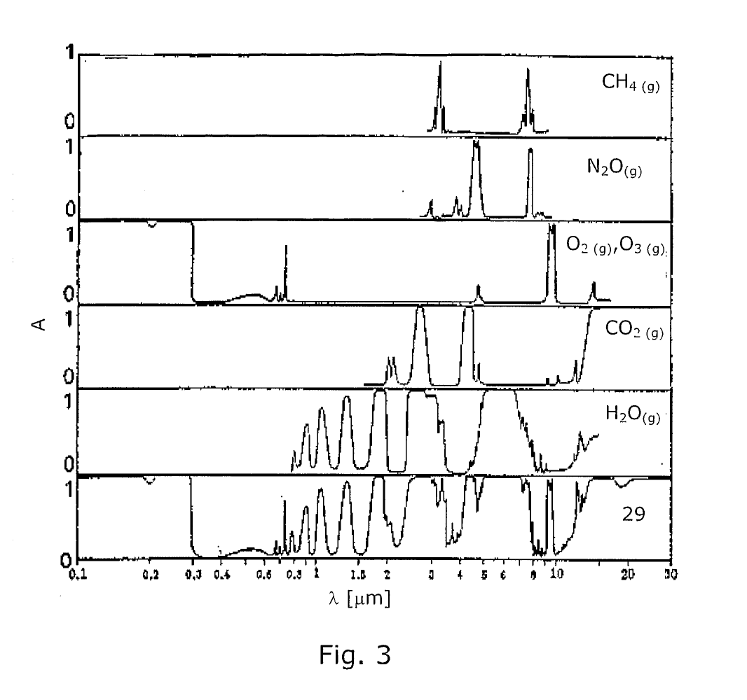

The IR sources used in IR spectrometers are typically thermal sources having an emission spectrum according to the Stefan-Boltzmann Law (black-body radiation). Typically, several things affect the recorded spectrum regardless of the substances of the sample. When recording spectra of water-dissolved samples, the liquid water absorption has a drastic effect on the recorded spectrum. Also, in most spectrometers, the IR beam propagates the air and therefore interacts with the constituents of the air giving rise to characteristic patterns in the spectrum. FIG. 3 shows comparative absorption spectra of the constituents of atmospheric air (from J. N. Howard, 1959, Proc. I.R.E. 47, 1459 and G. D. Robinson, 1951, Quart. J. Roy. Meteorol. Soc. 77, 1531). The bottom most spectrum 29 is the absorption spectrum of atmospheric air. Water vapour has several dominating absorption bands, and the spectrometer is typically dried up to remove water vapour.

According to the present invention, the spectrometer is standardised by using a well-known spectral pattern (e.g. an absorption peak) originating from a naturally occurring constituent of the atmospheric air present in the spectrometer. These peaks are recorded in a spectrum of a sample anyway since the light interacting with the sample propagates through atmospheric air. Spectrum 29 shows several distinguishable peaks which could be used for standardisation according to the present invention. There are two major criteria in the selection of a spectral peak for standardisation; first, the position (wavelength, frequency) must be within the spectrum recorded by the spectrometer. Secondly, the peak must also be distinguishable in the spectrum of the sample where spectral features from many other constituents occur.

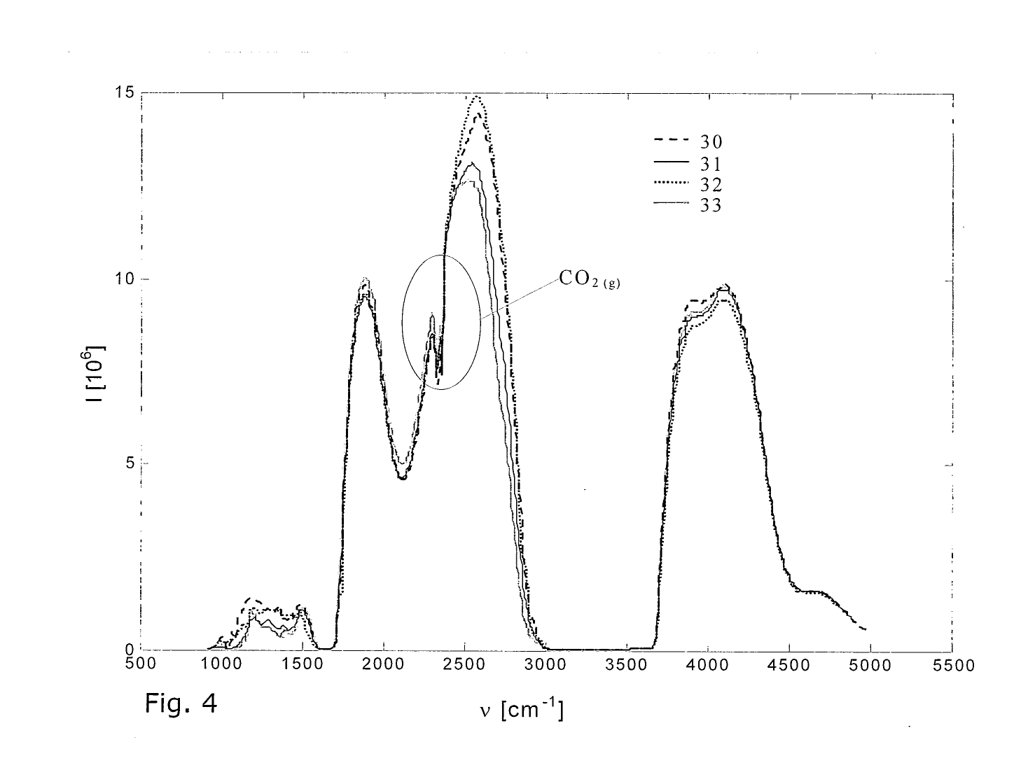

FIG. 4 shows typical spectra (transmitted intensity as a function of frequency) of four liquid samples, namely:
spectrum 30—White wine,
spectrum 31—Grape juice,
spectrum 32—UHT milk,
spectrum 33—Glucose in water.

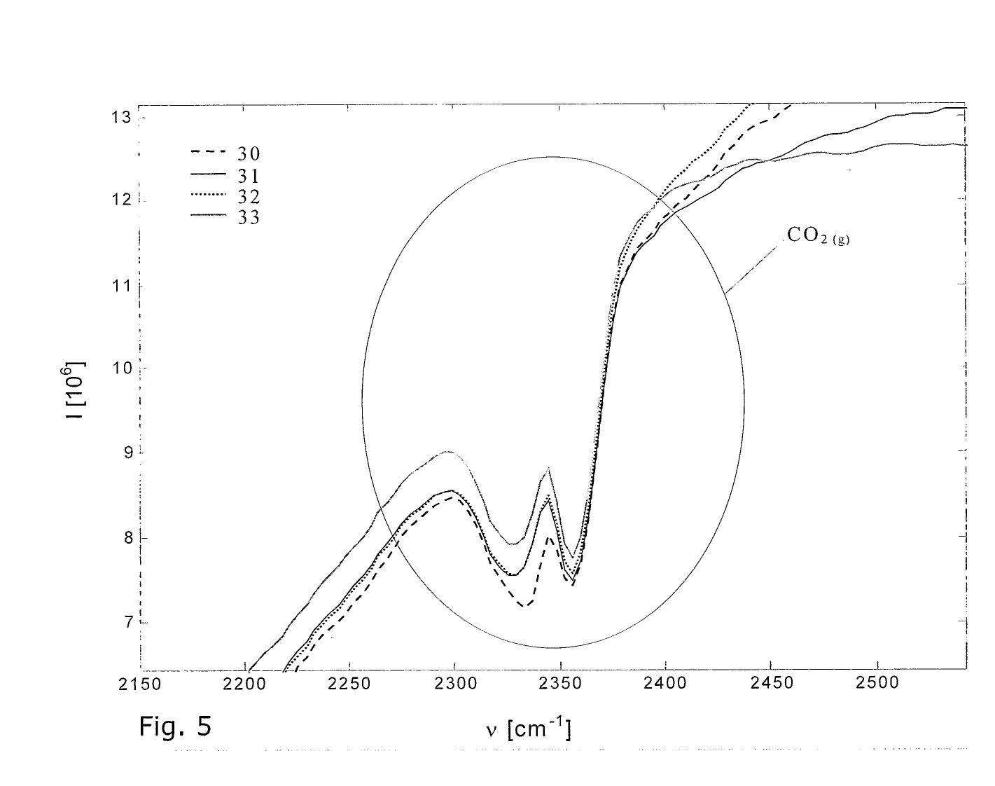

As relied upon by a preferred embodiment of the present invention, such spectra contain a characteristic absorption pattern around 2350 cm⁻¹, namely two absorption peaks from gaseous CO₂ naturally occurring in the spectrometer. FIG. 5 shows a close-up of these peaks from spectra 30-33 of FIG. 4. These peaks are also visible in spectrum 29 of FIG. 3, where the spectrum is not convoluted with the emission spectrum from an IR light source. These peaks are clearly fulfilling the criteria to the selected spectral pattern mentioned above, also for most other IR spectra.

As the true positions (in wavelength/frequency) of the selected CO_{2 (g)} peaks does not depend on temperature, pressure or other varying conditions (at least in normally occurring measuring environments), they can be used as a reference point in the standardisation of the spectrum and spectrometer.

The computer 18 is used to determine the recorded (or local) position of the selected spectral pattern (whether originating from CO_{2 (g)} or another constituent). For this purpose, the computer 18 holds programmes for determining a value for a centre of the selected pattern, comparing the determined centre value with a reference centre value obtained from a master instrument, and calculating a standardisation formula for spectrometer.

If the selected spectral pattern does not stand out from the spectrum, the programmes can also isolate the selected peak(s) from spectral components from other substances as well as the emission spectrum of the incident light. The computer 18 includes storage holding data related to the selected spectral pattern, such as data relating to a predetermined wavelength range within which the selected spectral pattern is to be found and a reference centre value obtained from a master instrument.

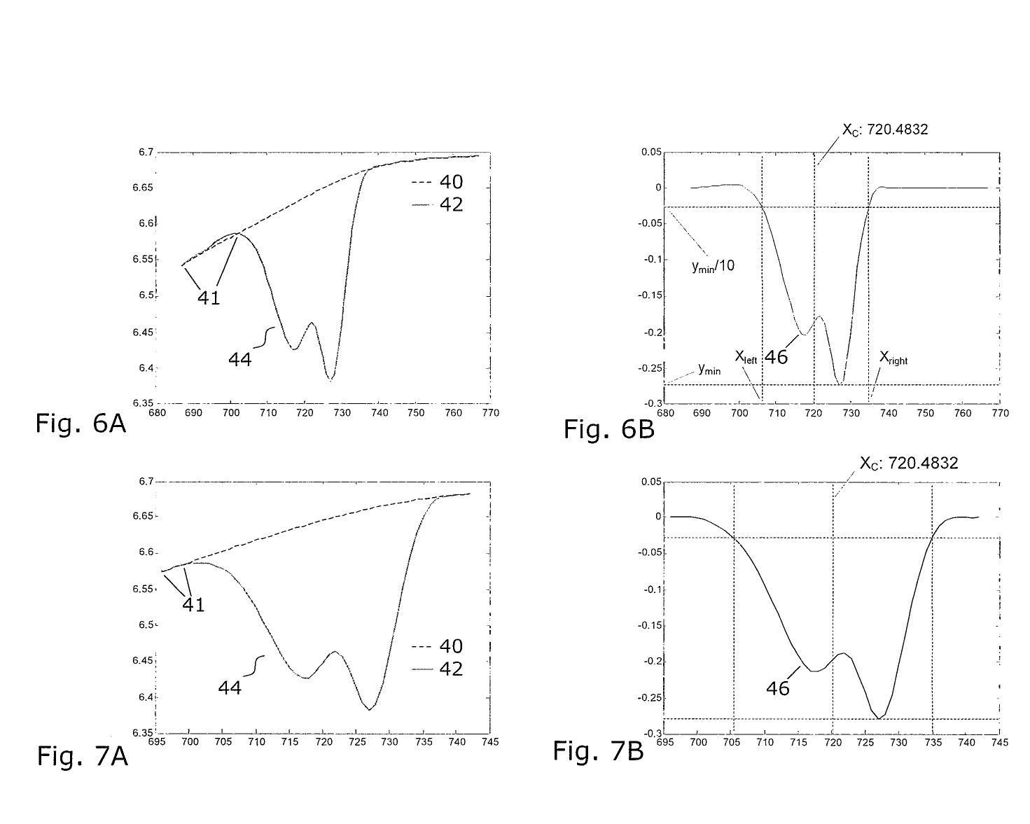

In the following, a detailed description of a preferred procedure for identifying the selected spectral pattern is given with reference to the preferred selected spectral pattern; two absorption peaks from gaseous CO₂ located around 2350 cm⁻¹. This procedure can be carried out by algorithms of software installed on the computer 18. The procedure is described with reference to FIGS. 6A-B and 7A-B and involves the following steps:

1) Subtract a baseline: In FIGS. 6A and 7A, fit a simple model function 40 (spline, polynomial, etc.) to selected values of the spectra 42 that lie outside the selected pattern 44. For the CO_{2 (g)} peaks, values in the ranges 2250-2300 cm⁻¹ and 2400-2450 cm⁻¹ can safely be used. The fitted function is subtracted from the original spectrum resulting in curve 46 on FIGS. 6B and 7B.

2) Locate the global minimum between 2250 cm⁻¹-2450 cm⁻¹ of curve 46. This value is designated Yₘᵢₙ and does not necessarily coincide with one of the peaks.

3) Locate edge values of the dip in curve 46. Preferably, the edge values are the first values on each side of Yₘᵢₙ that are a predetermined percentage or fraction of Yₘᵢₙ, for example k·Yₘᵢₙ, kε[0;1] or Yₘᵢₙ/n, nε[1;10]. The two corresponding positions on the X-axis are designated X_{left} and X_{right}.

4) The centre value of the selected spectral pattern is the centre between the spectral edge values determined by:

X_{c}=(X_{left}+X_{right})/2+X_{left}.

Alternatively, the edge values can be determined as points on the flanks of 46 with a predetermined inclination, e.g. dy/dx=±a, aε[0.01;0.02]. This procedure can replace steps 2 and 3 above, but care should be taken not to obtain an edge value on the dip between the peaks instead of on the flanks on the collected pattern 46. Again, the two corresponding positions on the X-axis are designated X_{left} and X_{right}.

In the above procedures, it is an important feature that it is the edges of the pattern which are used to determine a centre value of the pattern. As previously mentioned, CO_{2 (aq)} has an absorption peak within the pattern which can distort the position of the peaks from CO_{2 (g)}. Since the peak from CO_{2 (aq)} lies almost symmetrically and is typically smaller than the peaks from CO_{2 (g)}, the distortion does not shift the position of the edges of the pattern. Similarly, the amount of CO₂ in the atmosphere and in the sample does not matter. Increasing the amount will increase each peak symmetrically, whereby the flanks are shifted symmetrically.

In another alternative, a characteristic position of the CO₂ peaks can be obtained by the following procedure:

1) Subtract a baseline as described in the above.
2) Estimate the position of CO_{2 (g)} and CO_{2 (aq)} using spectra of pure CO_{2 (g)} and CO_{2 (aq)} by a curve fitting procedure.

Hereafter the position of one of the peaks can be compared to the similar peak in a spectrum recorded by the master instrument (or any previously defined position).

In any of the above alternatives, a corrected wavelength scale, λ_{corr}, for any wavelength ε_{local} of the recorded spectrum can be calculated using the ratio between the centre value determined using the local spectrometer and a reference centre value determined using a master instrument;

$${λ}_{corr} = {λ}_{local} \frac{{X}_{c master}}{{X}_{c local}} .$$

This formula is the standardisation formula. X_{c} is typically a wavelength or a frequency, but the nomination of the X-axis is not of importance, as long as it identical to the one used by the determination of a centre value from the master instrument.

In order to be able to compare the determined centre value with a reference centre value from a master instrument, the same procedure should be used in obtaining these centre values. Hence, the computing part 3 of the spectrometer 1 should apply the same procedure as the one applied in the master instrument. In the procedures presented in the above, there are a number of parameters (k, n and a) whose exact values may affect the centre value. Also, different procedures or approaches to determine a centre value may yield slightly different results. It is not important whether the results from applied parameters or different procedures are the same, but that the same parameter and procedure are applied in both the master instrument and in the local spectrometer.

Also, a number of different procedures to determine a value of a characteristic feature or features of a selected spectral pattern are presented in the above. The person skilled in the art may find different procedures which ultimately lead to the determination of such characteristic value(s) of a selected spectral pattern originating from a constituent of atmospheric air in the spectrometer. Any such procedure is considered to fall within the scope of the present invention.

1. A method for adjusting the wavelength scale of an optical spectrum recorded by a spectrometer
providing an optical spectrum recorded by the spectrometer and comprising spectral patterns originating from constituents of atmospheric air in the spectrometer,
selecting a spectral pattern originating from constituents of atmospheric air in the spectrometer,
determining a wavelength dependent position value associated with the selected spectral pattern, and
adjusting a wavelength scale of the optical spectrum based on a difference between the determined value and a corresponding reference value of the selected spectral pattern.

2. The method according to claim 1, wherein the wavelength dependent position value associated with the selected spectral pattern is a centre value of the selected spectral pattern.

3. The method according to claim 1, wherein the step of determining a wavelength dependent value comprises removing spectral components from other substances within a predetermined wavelength range surrounding the selected spectral pattern.

4. The method according to claim 3, wherein the removal of spectral components comprises the steps of
selecting at least two spectral values inside a predetermined wavelength range comprising the selected spectral pattern, the values lying on both sides of, and outside of, said spectral pattern,
fitting a curve to the selected spectral values using a simple model function, and
subtracting the fitted curve from the optical spectrum, at least for the predetermined wavelength range of the optical spectrum.

5. The method according to claim 1, wherein the selected spectral pattern originates from gaseous carbon dioxide (CO_{2(g)}) and is located in the interval 2000-2800 cm⁻¹.

6. The method according to claim 1, wherein the optical spectrum further comprises an optical spectrum of a sample of interest positioned in the spectrometer.

7. An infrared spectrometer comprising a measuring part and a computing part, the measuring part comprising a light source for emitting infrared light, means for positioning a sample of interest to be illuminated by the infrared light, a light detector positioned to receive infrared light having interacted with the sample, and
the computing part comprising
means for generating an optical spectrum from data received from the light detector,
data defining a predetermined wavelength range of the optical spectrum in which a spectral pattern originating from a constituent of atmospheric air in the spectrometer lies,
means for determining a wavelength dependent position value associated with the selected spectral pattern, and
means for comparing the determined value with a corresponding reference value and calculating a standardisation formula for the optical spectrum.

8. The infrared spectrometer according to claim 7, wherein the computing part further comprises means for at least substantially removing spectral components from the light source and other substances within the predetermined wavelength range.

9. The infrared spectrometer according to claim 7, wherein the infrared spectrometer is a Fourier Transform Infrared (FTIR) spectrometer.

10. The infrared spectrometer according to claim 7, wherein the spectral pattern originates from gaseous carbon dioxide (CO_{2(g)}) and is located in the interval 2000-2800 cm⁻¹.

11. The infrared spectrometer according to claim 7, wherein the optical spectrum further comprises an optical spectrum of a sample of interest positioned in the spectrometer.

12. The infrared spectrometer according to claim 8, wherein the means for at least substantially removing spectral components comprises an algorithm for performing the following steps:
selecting at least two spectral values inside the predetermined wavelength range, the values lying on both sides of, and outside of, said spectral pattern,
fitting a curve to the selected spectral values using a simple mode function, and
subtracting the fitted curve from the optical spectrum, at least for the predetermined wavelength range of the optical spectrum.

13. The infrared spectrometer according to claim 7, wherein the wavelength dependent position value is determined as a centre value of the selected spectral pattern.

14. The infrared spectrometer according to claim 13, the means for determining a wavelength dependent position value comprises an algorithm for performing the following steps:
determining a minimum spectral value within the predetermined wavelength range,
identifying spectral edge values being a predetermined percentage of the minimum value,
determining a value for the centre between the spectral edge values, this centre value being the value for the centre of the spectral pattern.

15. A data carrier holding data representing
software means for generating an optical spectrum from optical frequency data and corresponding spectral data,
data defining a predetermined wavelength range of the optical spectrum in which a spectral pattern originating from a constituent of atmospheric air lies and a reference value for a wavelength dependent position value of a predetermined feature of the spectral pattern,
software means for determining a wavelength dependent position value for the predetermined feature of the spectral pattern in the optical spectrum, and
software means for comparing the determined value with the reference value and calculating a standardisation formula for the optical spectrum.
